(19) United States
(12) Patent Application Publication
(10) Pub. No.: US 2007/0060319 A1
(43) Pub. Date: Mar. 15, 2007

(54) Gaming network for use in a restricted-access progressive game

(75) Inventors: Rory Lee Block, Carson City, NV (US); Christopher W. Blackburn, Reno, NV (US); Chih-Hui Jan, Reno, NV (US); Erhard Walter Rathsack, Reno, NV (US); Richard T. Schwartz, Chicago, IL (US); James P. Simmermon, Reno, NV (US); Terry Dean Warkentin, Carson City, NV (US)

Correspondence Address: JENKENS & GILCHRIST, P.C., 225 WEST WASHINGTON, SUITE 2600, CHICAGO, IL, 60606, US

(73) Assignee: WMS GAMING INC., Waukegan, IL (US)

(21) Appl. No.: 10/571,372

(22) PCT Filed: Sep. 3, 2004
(86) PCT No.: PCT/US04/29193

§ 371 Date: Mar. 9, 2006

Related U.S. Application Data
(60) Provisional application No. 60/502,749, filed on Sep. 12, 2003.

(51) Int. Cl. G06F 19/00

(52) U.S. Cl. 463/27

(57) ABSTRACT

A gaming system for playing a restricted-access progressive game comprises a database containing data, including a list of players having access to the restricted-access progressive game. The system includes a gaming terminal with a connection port for coupling the gaming terminal to the data-base. The gaming terminal has a player-identification device providing player information. The information is compared with data in the database to determine whether the restricted-access progressive game can be activated and game information displayed at the gaming terminal. A method of operating the progressive game comprises receiving a player-identification input at the gaming terminal and transmitting a player-identifier signal from the gaming terminal to a remotely located controller that determines accessibility to the progressive game. The method further includes receiving, at the gaming terminal, a progressive game accessibility signal from the remotely located controller and, if the signal is positive, allowing a player to conduct the progressive game.

### BACKGROUND OF THE INVENTION

The present invention relates generally to gaming machines and, more particularly, to a gaming terminal and a gaming network having an enhanced progressive game which is accessible by only a certain individual, or a limited number of players.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by increasing the entertainment value and excitement associated with the game.

One concept that has been successfully employed to enhance the entertainment value of a game is that of a “secondary” or “bonus” game which may be played in conjunction with a “basic” game. The bonus game, which is entered upon the occurrence of a selected event or outcome of the basic game, may comprise any type of game, either similar to or completely different from the basic game. Such a bonus game produces a significantly higher level of player excitement than the basic game because it provides a greater expectation of winning than the basic game.

Another concept that has been employed to enhance player entertainment is the use of progressive games. In the gaming industry, a “progressive” game involves collecting coin-in data from participating gaming device(s) (e.g., slot machines), contributing a percentage of that coin-in data to a progressive jackpot amount, and awarding that jackpot amount to a player upon the occurrence of a certain jackpot-won event. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In the existing progressive games, the progressive jackpot is available to anyone who is playing at a gaming terminal that is participating in the progressive game. In other words, all players of a progressive game feel as though they are being treated equally, and no special status is awarded to any one player. If a player recognizes that he or she is being uniquely rewarded in a way that is not available to the general public, however, then he or she is much more likely to play a game longer.

While some progressive game features provide some enhanced excitement, there is a continuing need to develop new features for progressive games to satisfy the demands of players and operators. Preferably, such new features for progressive games will further enhance the level of player excitement. The present invention is directed to satisfying these needs in that it provides access to a progressive game to only a certain person or groups of persons.

### SUMMARY OF THE INVENTION

The present invention relates to a restricted-access progressive game that is accessed only by a single player or a select group of players such that entry to the progressive game is based on permission given by the control system operating the progressive game. A gaming system for playing a restricted-access progressive game comprises a database containing data, including a list of players having access to a restricted-access progressive game. The system also includes at least one gaming terminal with a connection port for coupling the gaming terminal to the database. The gaming terminal has a player-identification device providing information about a player at the gaming terminal. The information is compared with the data in the database to determine whether the restricted-access progressive game can be activated by a player providing inputs at the player-identification device. The gaming terminal further includes a display for displaying an outcome of the restricted-access progressive game.

Alternatively, a gaming system for playing a restricted-access progressive game comprises (i) a progressive game database, (ii) a progressive game controller, and (iii) at least one gaming terminal. The progressive game database contains data, including a list of players having access to certain restricted-access progressive games. The progressive game controller controls the operation of the restricted-access progressive game and is coupled to the progressive game database. The gaming terminal is coupled to the progressive game controller and includes a player-identification device providing information about a player at the gaming terminal. The gaming terminal sends a player-identifier signal to the progressive game controller and, in response to receiving the player-identifier signal, the progressive game controller sends a signal to the gaming terminal indicating whether the player has access to a restricted-access progressive game.

The present invention also contemplates a method of operating a progressive wagering game. The method comprises receiving a player-identification input from a player at a gaming terminal, and transmitting a player-identifier signal from the gaming terminal to a remotely located controller that determines accessibility to the progressive wagering game. The method further includes receiving, at the gaming terminal, a progressive game accessibility signal from the remotely located controller and, in response to the progressive game accessibility signal being positive, allowing a player to conduct the progressive wagering game.

The above summary of the present invention is not intended to represent each embodiment, or every aspect, of the present invention. This is the purpose of the Figures and the detailed description which follow.

### BRIEF DESCRIPTION OF THE DRAWINGS

The foregoing and other advantages of the invention will become apparent upon reading the following detailed description and upon reference to the drawings.

FIG. 1 illustrates a gaming terminal that is useful for operating a restricted-access progressive game in accordance with the present invention.

FIG. 2 illustrates a control system that is used in conjunction with the gaming terminal of FIG. 1.

FIGS. 3A and 3B illustrate a card having multiple media that can be read by the gaming terminal of FIG. 1 to determine whether a player is eligible for the restricted-access progressive game.

FIG. 4 is an alternative embodiment of the gaming terminal that includes different devices for identifying the player.

FIG. 5 illustrates a flow chart for conducting play in accordance with the restricted-access progressive game.

FIG. 6 illustrates one embodiment for a network that is useful for conducting restricted-access progressive games.

FIG. 7 is an alternative embodiment to the network of FIG. 6 that is useful for conducting restricted-access progressive games.

FIG. 8 is another alternative embodiment to the network of FIG. 6 that is useful for conducting restricted-access progressive games.

FIG. 9 is a further alternative embodiment to the network of FIG. 6 that is useful for conducting restricted-access progressive games.

FIG. 10 is yet another alternative embodiment to the network of FIG. 6 that is useful for conducting restricted-access progressive games.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

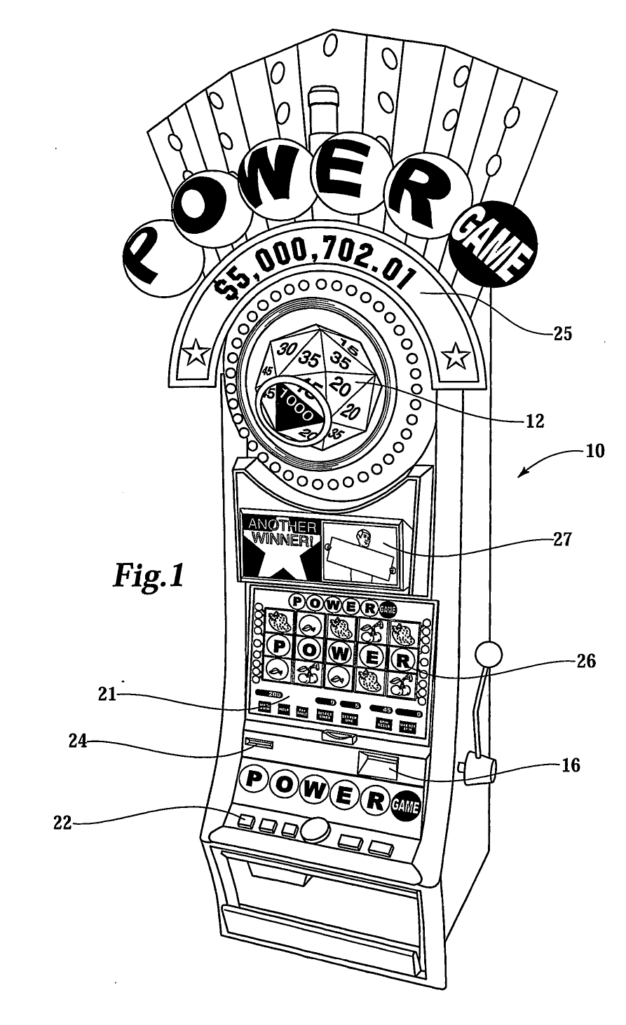

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play a video casino game such as blackjack, slots, keno, poker, etc.

As shown, the gaming terminal 10 has a top box including a rotating element 12 for playing a bonus game that may be played during or after the player has played the basic wagering game associated with the gaming terminal 10. The gaming terminal 10 includes input devices, such as a wager acceptor 16, a touch screen 21, and a push-button panel 22, and a player-identification card reader 24. For outputs, the gaming terminal 10 includes a progressive game display 25 for displaying the value of a progressive game, a main display 26 for displaying information about the wagering game, and a secondary display 27 that can display game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The wager acceptor 16 may include a coin slot acceptor or a note acceptor to input value to the gaming terminal 10. Or, the wager acceptor 16 may include a card-reading device for reading a card that has a recorded monetary value with which it is associated.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The operation of the basic wagering game is displayed to the player on the main display 26. The main display 26 may take the form of a cathode ray tube (CRT), a high resolution LCD, a plasma display, LED, or any other type of video display suitable for use in a gaming terminal 10. As shown, the main display 26 includes a touch screen 21 overlaying the entire monitor (or a portion thereof) to allow players to make game-related selections. In the alternative, instead of a main display 26, the gaming terminal 10 may have a number of mechanical reels to display the game outcome.

The player-identification card reader 24 allows for identification of a certain player. Currently, the identification is used by gaming establishments for rewarding certain players with complimentary services or special offers. For example, a player may be enrolled in the gaming establishment's player club and may be awarded certain complimentary services as that player collects points in his or her player-tracking account. The player inserts his or her card into the player-identification card reader 24, which allows the casino's computers to register that player's play at the gaming terminal 10. The gaming terminal 10 may use the secondary display 27 for providing the player with information about his or her account or other player-specific information.

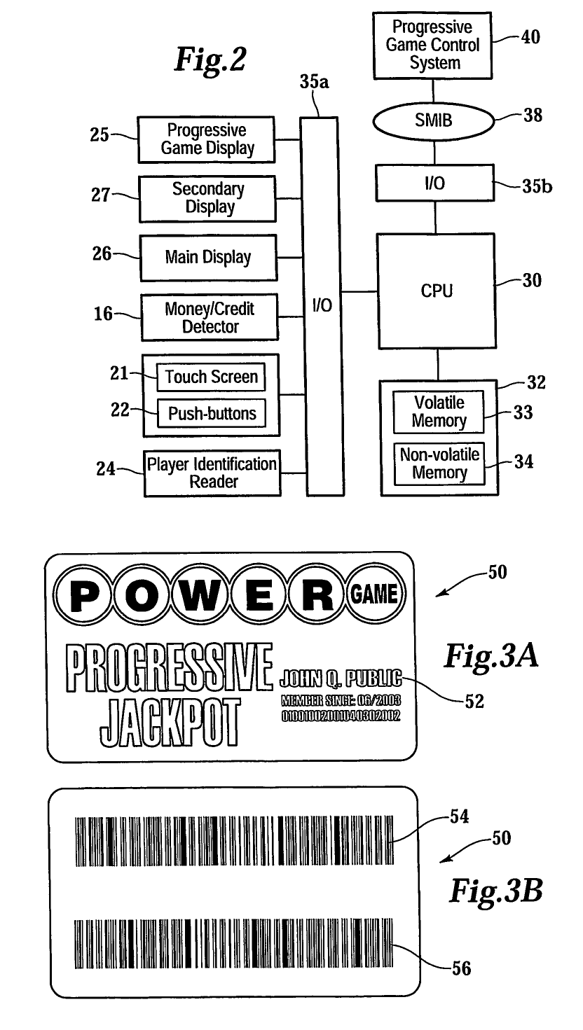

As shown in FIG. 2, the various components of the gaming terminal 10 are controlled by a central processing unit (CPU) 30 (such as a microprocessor or microcontroller). To provide the gaming functions, the CPU 30 executes a game program. The CPU 30 is also coupled to or includes a system memory 32. The system memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

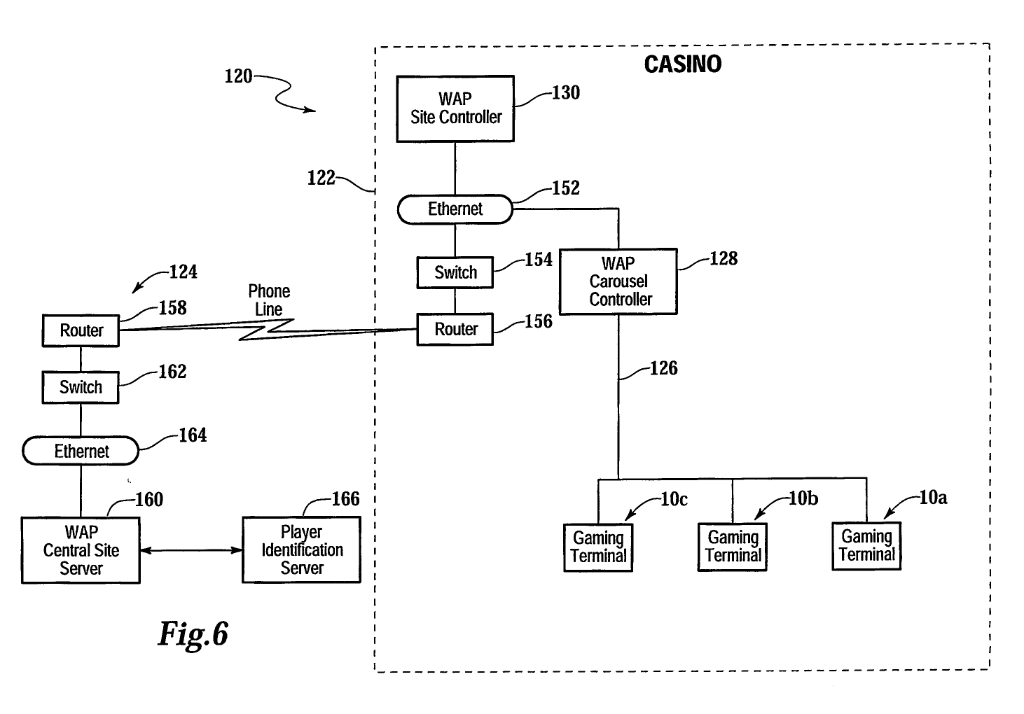

As will be discussed in more detail below with respect to FIGS. 6-10, the gaming terminal 10 is typically operated as part of a gaming network which, with regard to the present invention, includes a progressive game control system 40 that controls the play of the restricted-access progressive games and includes control circuitry and memory devices. Thus, the gaming terminal 10 often has multiple serial ports, each port dedicated to providing data to a specific host computer system that performs a specific function (e.g., accounting, player-tracking, or a progressive game control system 40, etc.). To set up a typical serial communication hardware link to the host system, the typical RS-232 point-to-point communication protocol that is often present in the gaming terminal 10 is converted to an RS-485 (or RS-485-type) master-slave protocol. To perform this function, a Slot Machine Interface Board (SMIB) 38 is used by the gaming terminal 10. One SMIB 38 is typically present for each communication port in the gaming terminal 10.

The conversion from the RS-232 to the RS-485 protocol eliminates some weaknesses of the RS-232 protocol. One weakness is that each gaming terminal 10 must be separately wired to each host computer if only the RS-232 standard were used. The RS-485 standard provides a multi-drop capability that allows many gaming terminals 10 to communicate with the progressive game control system 40 or other network control system. Thus, when considering a gaming system having multiple gaming terminals 10, a single communication interface can tap into all of the gaming terminals 10 by connection to the RS-485 data line, minimizing wiring requirements.

In addition to storing the communication protocol for the gaming terminal 10, the SMIB 38 may also have an embedded proprietary host communication protocol. The SMIB 38 converts the RS-232 input data from a proprietary gaming terminal protocol (e.g., IGT's Slot Accounting System (SAS) protocol or Bally's Simple Serial (BESS)) to the RS-485 (or proprietary RS-485-type) host communication protocol. The SMIB 38 may poll the gaming terminal 10 for data, as with the SAS protocol, or the SMIB 38 may only listen for data being transmitted from the gaming terminal 10 as it is produced on an event-driven basis. This data is stored on the SMB 38 and is accessible to the host or polling computer via the RS-485 side of the SMIB 38. The RS-485 side of the SMB 38 takes that data, when polled by the host, which in this case is the progressive game control system 40, and transmits it typically in a proprietary RS-485-type communication protocol to the progressive game control system 40. It should be noted that the gaming terminal 10 can initially be designed to be configured for a typical RS-485 protocol, instead of the typical RS-232 protocol.

FIGS. 3A-3B illustrate a player-identification card 50 that is inserted into the gaming terminal 10 by a player. The player-identification card 50 can simply carry identification data, or can also carry an associated monetary value that may be alterable, like a smartcard. The first side of the player-identification card 50 includes information 52 about the player (i.e., John Q. Public). The second side includes at least one type of media that can be read by the player-identification card reader 24 (FIGS. 1 and 2) within the gaming terminal 10. Preferably, the player-identification card 50 includes at least two different media 54, 56 that are read by two different reading devices within the player-identification card reader 24, or by a single reader with the capability of reading multiple media. By providing at least two different media on the player-identification card 50, the player can utilize one card 52 for serving multiple functions within the gaming establishment. For example, the first media 54 can be used for identifying the player in a database that is used for player tracking within the gaming establishment so as to reward loyal patrons, while the second media 56 can be used for identifying the player for purposes of providing access to a specific type of game, such as a restricted-access progressive game.

As shown, the first media 54 and the second media 56 are both bar codes. Alternatively, one or both of the media 54, 56 can be a magnetic stripe. As a further alternative, the player-identification card 50 may include a contactless media, such as a radio frequency identification device (RFID). Using an RFID, the gaming terminal 10 would need to include a device (e.g., transceiver or receiver) adjacent to or within the player-identification card reader 24 that communicates with the RFID transponder located on the player-identification card 50. Accordingly, the media 54 may be an RF transponder that, when located within a certain distance of the gaming terminal 10, provides player-identification data to the player-identification card reader 24 that is further transferred to the CPU 30 (FIG. 2). RFID components can be those available from Pacific Northwest National Laboratory (under the United States Department of Energy) of Richland, Wash.

Accordingly, the present invention contemplates a gaming terminal 10 that can receive the player-identification card 50 having multiple media, including perhaps different types of media for the player-identification card 50, so as to retrieve identification information about a player. Such a player-identification card 50 and the corresponding player-identification card reader 24 within the gaming terminal 10 provide substantial flexibility when performing various tasks that require separate player identification functions at the gaming terminal 10. As one example, which is described below with respect to FIG. 6, a player inserts one player-identification card 50 having the first media 54 and the second media 56, and the first media 54 provides the player's identity to a casino player-tracking system and the second media 56 provides the player's identity to a progressive game network.

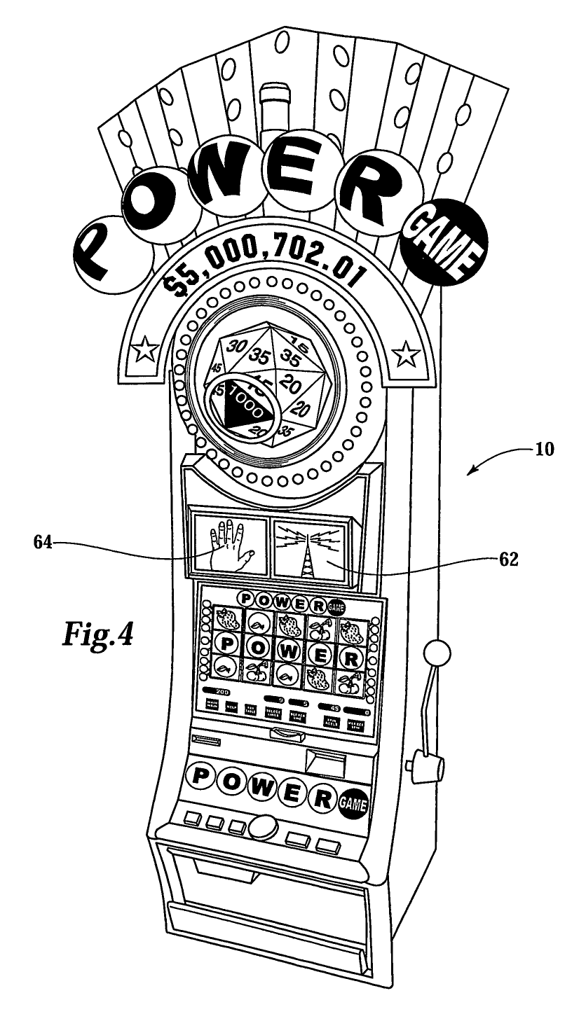

FIG. 4 illustrates the gaming terminal 10 of FIG. 1 that has been modified to include other forms of player identification for the purposes of accessing the restricted-access progressive game that is available at the gaming terminal 10. While FIGS. 3A and 3B discuss the concept of the player-identification card 50, including an RFID transponder that identifies the player by use of a transceiver or receiver adjacent to or within the player-identification card reader 24, the gaming terminal 10 may include a transceiver or receiver 62 located at another portion of the gaming terminal 10 that is different from the player-identification card reader 24. Here, the gaming terminal 10 includes the RFID transceiver or receiver 62 so that an RFID transponder held by the player can be used to identify the player at the gaming terminal 10 without the need to insert a card into the gaming terminal 10.

Alternatively, the gaming terminal 10 of FIG. 4 may include a biometric reading device 64 for recognizing a distinguishable physical attribute of a player so as to identify the player for providing access to the restricted-access progressive game. As shown, the biometric reading device 64 is contacted by the hand of the player to read the geometry of the hand or the fingerprints on one or more of the fingers. After the biometric reading device 64 scans the information, a controller (either locally or at a remote location) performs a comparison to determine the identification of the player at the gaming terminal 10. Additional information regarding fingerprint scanning or hand geometry scanning is available from International Biometric Group LLC of New York, N.Y.

Other biometric identification techniques can be used as well for determining whether the player has access to a restricted-access progressive game. For example, a microphone can be used in the biometric identification device 64 so that a player can be recognized using a voice recognition system. In such a system, a player claims an identity, which is recorded, and his or her voice-print is matched to a voice-print on file to verify the player's identity. Further, the gaming terminal 10 may include a biometric identification device 64 that scans the retina or the iris for identifying whether the player has access to the restricted-access progressive game. Additional information regarding iris or retinal scanning is available from International Biometric Group LLC of New York, N.Y.

In another further alternative, the gaming terminal 10 may use a combination of the player-identification card 50 (FIG. 3) and some type of biometric identification technique for verifying information. In other words, the biometric identification is like a P.I.N. used with the player-identification card 50. Thus, the gaming terminal 10 can ensure that it is permissible for the player who has inserted the player-identification card 50 into the gaming terminal 10 to access the restricted-access progressive game associated with that player-identification card 50.

Additionally, to determine a player's identity, the gaming terminal 10 can receive a player input in the form of a player identification name or number, and possibly an associated password. These inputs can be can be received through the touch screen 21 or the push buttons 22 (FIGS. 1 and 2). After receiving this information, the gaming terminal 10 allows the player to access the restricted-access progressive game that is associated with the player.

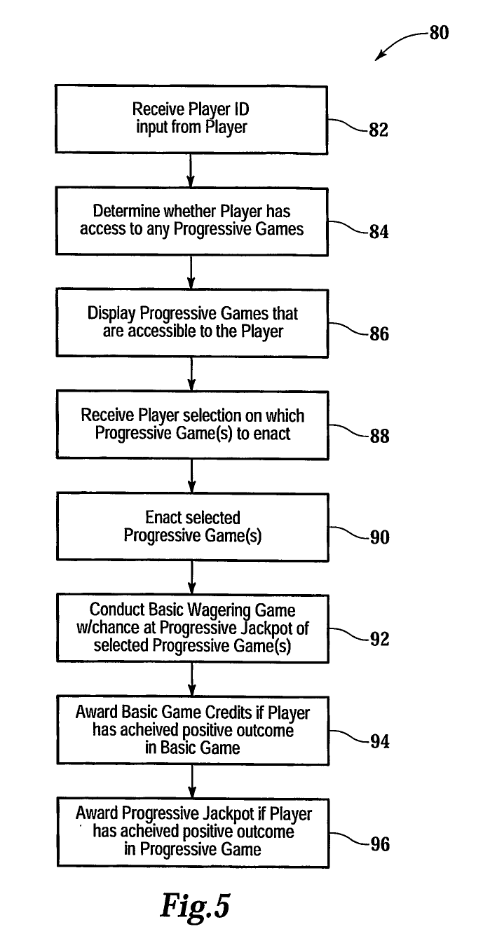

While FIGS. 3 and 4 illustrate various methods by which a player can be identified to determine whether that player has access to a progressive game, FIG. 5 illustrates a flow diagram that describes the general methodology 80 involved with playing the restricted-access progressive game. First, at step 82, the gaming terminal 10 receives information from the player regarding his or her identification. Then, at step 84, the gaming terminal 10, or a controller within the progressive gaming network, determines whether the player has access to any of the progressive games available at the gaming terminal 10. Next, at step 86, one of the displays at the gaming terminal 10 displays information to the player regarding which progressive games are accessible to him or her. Then, at step 88, the gaming terminal 10 receives player selections as to which progressive game he or she desires to enact. After receiving the selections, at step 90, the selected progressive game(s) is enacted and the player becomes eligible to win the jackpot(s) associated with the selected progressive game(s).

At step 92, the player begins playing the basic wagering game associated with the game terminal 10. Within step 92, a portion of the wager associated with the basic wagering game is allocated to the progressive game jackpot(s) associated with the selected progressive game(s). The gaming terminal 10 then awards the player credits if a positive outcome is achieved in the basic wagering game at step 94. Further, to the extent the player has achieved a positive outcome associated with the progressive game, the progressive jackpot is awarded to the player at step 96. The value of the progressive jackpot is typically known by the player prior to playing the progressive game, such as being displayed on the progressive game display 25 (FIG. 1) on the gaming terminal 10. It should be noted that, in addition to the progressive jackpot associated with the individual or group progressive game, the player can also be eligible for the jackpot for a publicly available progressive game accessible by the general public at the gaming terminal 10.

Several types of restricted-access progressive games can be played at the gaming terminal 10. For example, the restricted-access progressive game may only be available to one individual player. Or, the restricted-access progressive game may only be available to a selected group of players. In either scenario, the gaming terminal 10 must be able to uniquely identify the player so as to determine whether that player has access to one or more of the restricted-access progressive games. The various identification techniques described above with respect to FIGS. 3 and 4 are useful for this purpose.

Within the individual or personalized progressive game, which is played by only a single player, there are several variations for determining when the individual player is eligible for the progressive jackpot, but eligibility generally requires the player to be wagering at the maximum level for a particular basic wagering game (although the present invention is surely not limited to only a maximum-level wager requirement). In the most basic scenario, the player is eligible for the progressive jackpot every time the player engages the basic game at the gaming terminal 10, assuming the player is wagering at the maximum level. For example, if the gaming terminal 10 is a slot machine, each time the player pulls the handle while wagering at the maximum level, he or she has the possibility of winning the individual progressive jackpot in addition to achieving a winning outcome in the basic slot machine game. It should be noted that the progressive jackpot has a base level that is increased by funding provided only by that individual player. Thus, each time the player pulls the handle, a portion of the wager on the basic game is allocated to the individual progressive jackpot.

Alternatively, the player may become eligible for the individual progressive jackpot after a predetermined number of times playing the wagering game (e.g., 100 pulls of a slot machine handle). In this embodiment, the player receives a notification that eligibility for the individual progressive jackpot has occurred, either through some sort of audio cues that are broadcast from the gaming terminal 10 or video/animation cues on one of the displays 25, 26, 27 (FIG. 1). The progressive jackpot for this embodiment is funded each time the player places a wager on the basic wagering game, even though eligibility to win the progressive jackpot occurs less frequently. In this embodiment, the individual progressive game can be configured such that the number of plays of the wagering game from multiple sessions are added when counting toward the predetermined number of plays to become eligible for the progressive jackpot. Or, the player must achieve that predetermined number of plays in a single session to become eligible for the progressive jackpot.

In yet a further alternative, the player becomes eligible for the individual progressive jackpot only after a predetermined number of coins/credits are played. In this configuration, the progressive game could be set up such that after the predetermined number of coins have been input to the gaming terminal 10, the next time the player plays the basic wagering game at a maximum coin-in level, the player then has the opportunity to win the progressive jackpot during or after that specific play of the basic wagering game. Like the previous embodiment, adding coins/credits to reach the predetermined number can occur over multiple sessions by the player, or can be limited to only the coins/credits inputted by the player in one single session.

In another alternative to the individual progressive game, the player becomes eligible to win the progressive jackpot after inputting an additional side wager during play of the basic wagering game. Accordingly, while a portion of each of the player's wagers is allocated to the progressive jackpot for the individual progressive game, a player only becomes eligible to win the progressive jackpot after he or she “buys” a chance via a side wager.

In other alternatives, the player becomes eligible for the progressive jackpot by achieving a certain outcome or accomplishing a certain task in the basic wagering game. For example, when a certain combination of symbols are displayed in a slot machine, the player then becomes eligible to win the progressive jackpot. When doing so, the gaming terminal 10 may switch over into a progressive game mode in which the player is then focused only on winning the individual progressive jackpot. Alternatively, if the basic wagering game is a poker game, the player may achieve four chances at the progressive jackpot for every four-of-a-kind hand that occurs during the basic poker game, while achieving only one chance at the progressive jackpot for every three-of-a-kind hand. The progressive game jackpot can also be won through a bonus game that is coupled to the basic game, where the bonus game provides the individual player with the chance to win various prizes, one of which is the individual progressive jackpot. In other words, the progressive game jackpot is not awarded based on a simple random computer determination but, instead, on some type of selection on the part of the individual player during a bonus game.

To attract players to the gaming establishments during traditionally slow periods (e.g., a Tuesday), the eligibility for achieving the individual progressive jackpot may occur only during certain time periods or more frequently during slow periods. Further, a player may become eligible for a randomly selected individual mystery prize that is based on the amount of wagering that a player has made during a certain day, week, or month, etc. Such a mystery prize may be an alternative, or supplement, to the individual progressive jackpot for which the player is eligible.

This mystery prize can be periodically awarded (e.g., weekly or monthly) based on a random drawing of all players participating in individual or group progressive games and, thus, serves as an incentive for individuals to take part in an restricted-access progressive game. The winner of the mystery prize can be displayed on the secondary display 27 (FIG. 1) so as to attract other players to play the individual or group restricted-access progressive games. Of course, using the secondary display 27 to illustrate a recent winner of a prize associated with a wagering game is not limited to only winners of the mystery prize described above. Winners of any type of prize or bonus associated with a certain brand of gaming machine, a certain gaming terminal, or an entire gaming establishment can be displayed on the secondary display 27. Or, the secondary display 27 can display the image of the biggest loser for a certain day or week, while providing some type of special payout to that biggest loser.

In any of the embodiments involving an individual progressive game, the * progressive game may be configured such that the progressive jackpot is available for only a limited time period (e.g., a week, a month, or a year) and the value of the progressive jackpot is reset to the base value after that time period expires. Or, the individual progressive jackpot does not reset to the base value as long as the player plays the basic game a minimum number of times within a certain period of time. As an example, if the player plays the wagering game at least four different days during every month, the individual progressive jackpot increases by continuously allocating a portion of the wager to the progressive jackpot, such that the progressive jackpot is not reset to the base value.

In all of these variations of a restricted-access progressive game that is available to only a single player, the preferred embodiment involves a progressive game network that allows the player to continue to be eligible for and have access to the individual progressive jackpot by playing any one of a variety of wagering games that are connected to the gaming network. In other words, the individual player is not forced to play only one type of wagering game, but has a progressive jackpot that can be accessed and won by playing a number of different types of wagering games within a gaming establishment.

In another preferred embodiment of the restricted-access progressive game, wagering games that are available at numerous gaming establishments can be played by the individual player while having access to his or her specific individual progressive game at any of the gaming establishments. As an example, the individual progressive game may be offered by a specific manufacturer of gaming terminals that are linked to a central computer system that allows an individual player to access his or her specific individual progressive game anytime he or she plays a wagering game produced by that specific manufacturer, regardless of location. Gaming networks that are useful for these preferred embodiments are discussed in more detail with respect to FIGS. 6-10.

The previous paragraphs have discussed the concept of an individual progressive game that is accessed by only a single player. Another type of restricted-access progressive game allows access to a group having a limited number of players. In such an embodiment, the players can select a certain group to which they will be associated for a particular restricted-access progressive game. Alternatively, the control system for the progressive game network can group various individuals together to form a group that has access to a particular restricted-access progressive game. Entry of the information needed to develop a group can be performed at the gaming terminal 10, or at a station within the gaming establishment dedicated to such a function. In either type of method, the information related to the group is preferably stored by a control system dedicated to operating the restricted-access progressive games. Such a gaming network is discussed in more detail with respect to FIGS. 6-10.

In the most fundamental embodiment of a group progressive game, every player in the group is eligible for the progressive jackpot and the progressive jackpot is incremented upwardly from the base value each time one of the players in the group inputs a maximum value wager on the basic wagering game associated with the gaming terminal 10. Accordingly, for each wager input, assuming the wager input is at the maximum level, each player has the identical chance of winning the randomly selected progressive jackpot.

Alternatively, each player within a group becomes eligible for the group progressive jackpot after a predetermined number of times playing the basic wagering game (e.g., after every 30 pulls of a slot machine handle), or after wagering a certain amount on the basic gaming machine (e.g., after every $30 wagered on a video poker game). As discussed with respect to the individual progressive game, these increments that allow for the opportunity to win the group progressive jackpot can be reset after a particular gaming session or can be added over multiple gaming sessions. When a certain player within a group becomes eligible for a chance to win the group progressive jackpot, the gaming system may send a signal to each of the other players in the group to let them know that a certain player is about to play for a chance to win the group progressive jackpot.

Unlike the individual progressive game, the group progressive game can be configured such that every player within the group receives a chance to play for the group progressive jackpot after the entire group plays a predetermined number of games in the basic wagering game (e.g., after 200 total pulls of a slot machine handle), or after the group wagers a certain amount on the basic gaming machine (e.g. after every $100 wagered on the basic games played by the group). Further, the control system for the progressive game may keep track of which player within the group has been playing more and award that player additional chances to play for the group progressive jackpot. The skilled artisan will appreciate other types of incentives to create a competitive atmosphere among players within a group.

Like the individual progressive game, the group progressive game can be configured such that eligibility is based on a player within the group placing a side wager on the basic wagering game, achieving a certain outcome in the basic or bonus game (e.g., certain combinations of symbols on a slot machine, or selections made for prizes in the bonus game), or playing the basic game during certain periods of time (e.g., certain hours on a Tuesday evening). The group of players can also be eligible for a randomly awarded group mystery prize which is different from the group progressive jackpot.

The eligibility for winning a group progressive jackpot may require a certain level of participation by each player with the group. In other words, one player in the group who has contributed significantly less to the group progressive game jackpot may be instructed that he or she must make certain contributions to the progressive game jackpot to again be eligible to compete for the group progressive jackpot. Alternatively, an algorithm can be established such that failure to play for and contribute to the group progressive jackpot over a certain period of time causes a player to forfeit his or her opportunity to win and, thus, only the other players within the group have an opportunity to win the group progressive jackpot.

As a hybrid between the individual restricted-access progressive game and the group restricted-access progressive game mentioned above, a restricted-access progressive game can be designed where players are grouped together, but play for their own individual progressive game jackpot. When engaging the progressive game with the hopes of winning his or her own progressive jackpot, one possible randomly selected outcome in the progressive game is a “transfer to” outcome. If such an outcome is achieved, the player loses a portion (or all) of his or her individual jackpot to a second player within the group. Thus, the second player receives an additional amount in his or her individual progressive jackpot. Of course, the second payer could also achieve a “transfer to” outcome and be forced to transfer a portion (or all) of his or her individual jackpot (which includes the first player's jackpot) to a third player in the group, or perhaps back to the first player. The “transfer to” outcome can be specific in directing the player's individual jackpot (or portion thereof) to a specific player within the group, such that each player in the group has an associated “transfer to” possible outcome when others in the group are playing the progressive game. Or, after the first player knows that he or she has received the undesired “transfer to” outcome, he or she provides an input which then randomly selects the recipient player within the group.

Communication at the gaming terminals 10 among the players in the group regarding the occurrence of a “transfer to” outcome provides enhanced excitement and increases player competition. Further, the communication may be set up so that all players see who the randomly selected recipient is after the player who is losing his or her jackpot provides inputs to the gaming terminal 10 instructing the random selection of the recipient. As an alternative, all other players in the group can receive an equal share of what is transferred by the player receiving the undesirable “transfer to” outcome.

Accordingly, the present invention contemplates a progressive game where players can actually lose the opportunity to achieve a large progressive jackpot because that player's progressive jackpot is restricted to another player or group of players. It should be noted that, in addition to or in place of the “transfer to” outcome, the progressive game can be set up with a “transfer from” outcome, which is desirable because a player then “takes” another player's individual progressive jackpot. Regarding the amount of the progressive jackpot that is transferred to or transferred from a player, that amount can be limited to the amount above the base amount of the progressive jackpot (i.e., the amount that a specific player has contributed to the progressive game).

For the individual and group restricted-access progressive games described above, the base amount of the jackpot can be a variable that depends on the previous participation by the player or players. Consequently, the base level for the jackpot may be set at a gold level, a silver level, and a bronze level, depending on whether the player or group meets certain criteria. Further, any of the various embodiments of the restricted-access progressive game can structured to have multiple jackpot levels such that there are various winning outcomes within each restricted-access progressive game.

It should further be noted that the present invention contemplates one player having the ability to access several different restricted-access progressive games during one session of gaming at a specific gaming terminal 10. For example, a certain player may have his or her own individual restricted-access progressive game, while also participating in restricted-access progressive games associated with one or more groups. Such a player may enact one of the different restricted-access progressive games just prior to he or she wagering on the basic wagering game. Alternatively, the player may be able to access and play for more than one progressive jackpot as he or she engages the basic wagering game. This may require the player to input additional credits, or the progressive game network may be set up to provide incentives for this type of multiple-progressive game play without requiring additional credits. Furthermore, while playing for the progressive jackpot associated with the individual or group progressive game, the player can also be eligible for the jackpot for a publicly available progressive game accessible by the general public at the gaming terminal 10.

Additionally, the present invention is different from known progressive games that are accessible by any member of the general public in that the identity of the player who is playing for the progressive jackpot according to the present invention is known. This identity is stored in a database in communication with the control system for the restricted-access progressive game. This feature has several advantages, such as being able to tailor the presentation or operation of the progressive game to the specific likes of a particular player. Further, because the player's identify is known, the restricted-access progressive game can be structured such that one of the winning progressive game outcomes allows a particular player to be awarded 100% of all of the contributions ever made to one restricted-access progressive jackpot (which is advantageous when considering a restricted-access progressive jackpot may be available for only a limited time period before resetting to the jackpot's base value), or 100% of all of the contributions ever made by the player to any restricted-access progressive jackpot. Thus, this “historical pay-in” payout concept presents another type of possible winning outcome in the restricted-access progressive game, in addition to simply having winning outcomes associated with different jackpot levels described in the previous paragraphs.

FIG. 6 illustrates a network 120 that is useful for conducting the restricted-access progressive games that are described above. As used herein, this network 120 will be referred to as the wide-area progressive (“WAP”) network 120. The WAP network 120 typically includes components within a casino 122 and components at a remote location 124. Within the casino 122, a plurality of gaming terminals 10a, 10b, 10c are connected through a multi-drop serial line 126 to a WAP carousel controller 128. The multi-drop serial line 126 may be, for example, an RS-485 serial data line, which is compatible with and linked to the SMIB 38 (FIG. 2) within the gaming terminal 10. A WAP site controller 130 is connected to the WAP carousel controller 128 through an ethernet connection 152.

To link the WAP site controller 130 to the remote location 124, the casino 122 includes one or more switches 154 and routers 156. The router 156 within the casino 122 is connected through a phone line to a corresponding router 158 at the remote location 124. A WAP central site server 160 at the remote location 124 is coupled to the router 158 through a switch 162 and an ethernet connection 164. The WAP central site server 160 is connected to a player identification server 166 to allow for the exchange of player data and progressive game data stored within the player identification server 166.

In operation, a player identifies himself or herself to the WAP network 120 at the gaming terminal 10a through the player-identification card 50 having multiple media (FIG. 3.), an identification card with a single media that is specific to the progressive game network, entry of a login name and personal password or pin number, an RFID device, through biometric inputs, or any other method for identifying the player. Several types of player-identification inputs are described above with respect to FIGS. 3 and 4. The player's information is transmitted along the multi-drop serial line 126 and collected by the WAP carousel controller 128. As two of its functions, the WAP carousel controller 128 serves to quickly collect player-identification data from a plurality of gaming terminals 10a, 10b, 10c and to communicate progressive game information to selected ones of the gaming terminals 10a, 10b, 10c where progressive games are being played.

The player-identification data is collected at the WAP site controller 130 and processed into a format for transmission to the WAP central site server 160 at the remote location 124. After transmission to the WAP central site server 160, the data is compared to existing data within the player identification server 166. The identification of the player at the gaming terminal 10a occurs within the player identification server 166. Further, the player identification server 166 determines which, if any, restricted-access progressive games are associated with the identified player. Information related to the player and the associated restricted-access game is then transmitted to the WAP site controller 130. Based on this information from the remote location 124, the WAP site controller 130, via the WAP carousel controller 128, communicates with the gaming terminal 10a where the player has entered his or her identification information. The WAP site controller 130 is responsible for randomly selecting whether the player has won the individual or group progressive jackpot, incrementing the personal progressive jackpot, awarding the jackpot, and notifying the player of all other information related to the progressive game.

After the player has completed the gaming session at the gaming terminal 10a, all information concerning the game play that occurred in the restricted-access progressive game is transmitted from the WAP site controller 130 to the WAP central site server 160. Accordingly, updated player information and game play information regarding the restricted-access progressive game is stored within the player identification server 166. If the player attends a casino different from the casino 122 at a future date and the other casino is linked to the WAP central site server 160, the player can continue playing the updated version of the progressive game at the other casino. In other words, the present invention contemplates that the WAP central site server 160 can be linked to various types of gaming terminals in several casinos so that players can play their group or individual restricted-access progressive games at several different casinos.

The WAP network 120 of FIG. 6 provides an example where the player-identification card 50 (FIG. 3) having at least two media is useful. One media on the player-identification card 50 can be used for identifying a player for access to the restricted-access progressive games as described above. The second media on the same player-identification card 50 could be used for identifying the player in a player tracking system (not shown in FIG. 6) that is used by the casino 122 to provide special rewards to a certain player. As mentioned above, the single player-identification card 50 can have different types of media (e.g., bar code, magnetic stripe, RFID, etc.) for each of these functions.

The WAP network 120 in FIG. 6 is merely one example of many possible networks that can be developed to support a restricted-access progressive game. Many other types of connections between the gaming terminals 10a, 10b, 10c and the WAP site controller 130 and between the WAP site controller 130 and the player tracking server 133 can be utilized. Further, the WAP network 120 can be located entirely within the casino 122 and dedicated to only one casino 122, such that it performs all functions related to the restricted-access progressive game within the casino 122. In such an embodiment, all information regarding the player and his or her associated individual or group progressive games are stored locally in databases within the casino 122.

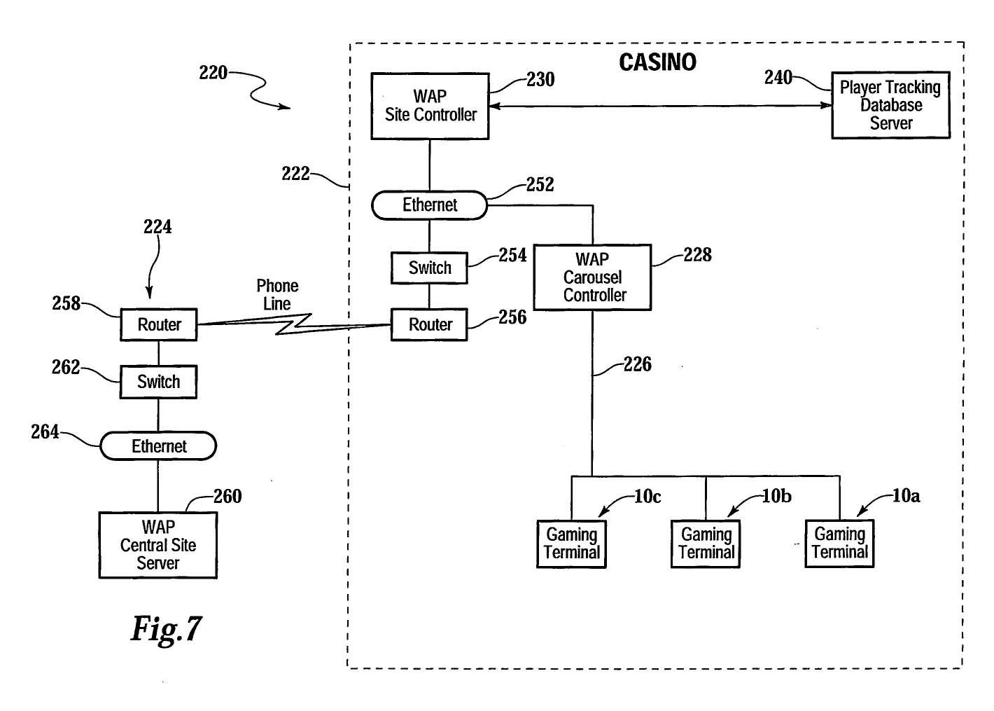

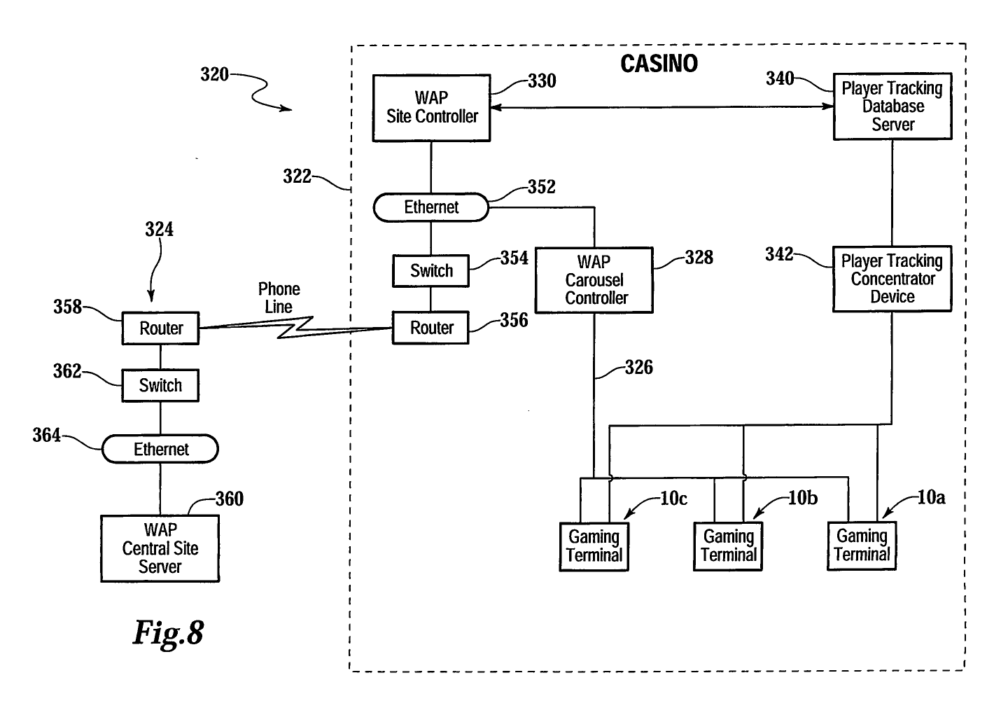

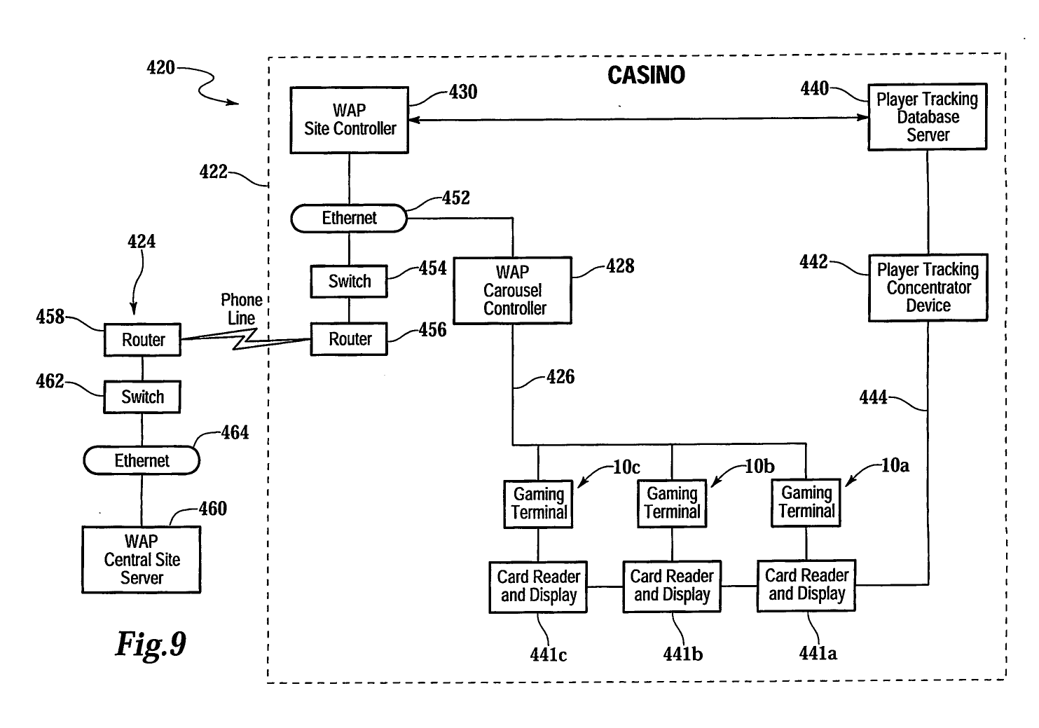

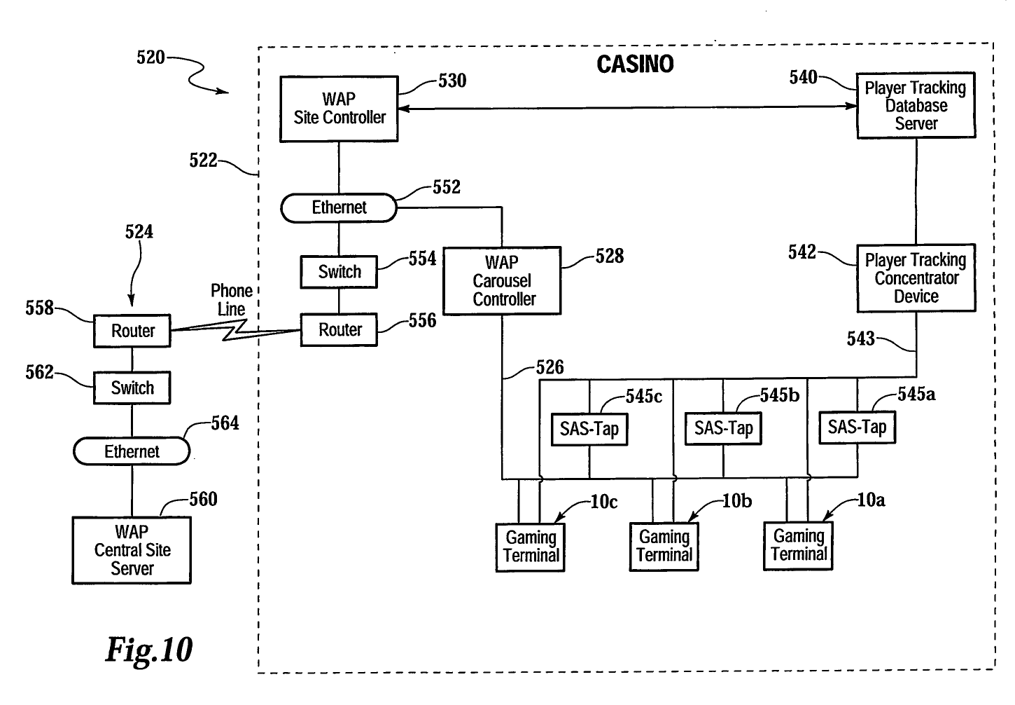

As previously mentioned, gaming establishments often use player tracking systems for rewarding certain players with complimentary services or special offers. FIGS. 7-10 illustrate gaming networks serving two purposes—providing information to the player tracking system and providing the necessary information to operate the restricted-access progressive games. For simplicity, these alternative networks in FIGS. 7-10 will be described with respect to reference numerals in the 200-series, 300-series, 400-series, and 500-series, respectively, in which commonly numbered items are similar components for performing similar functions (e.g., the WAP carousel controller 128 in FIG. 6 is similar to the WAP carousal controller 228 in FIG. 7, the WAP carousal controller 328 in FIG. 8, the WAP carousal controller 428 in FIG. 9, and the WAP carousal controller 528 in FIG. 10). Hence, many of the components that were described in detail with reference to FIG. 6 will not be described in detail with respect to FIGS. 7-10.

FIG. 7 illustrates a WAP network 220 that is similar to the WAP network 120 of FIG. 6. The casino 222, however, includes a player tracking database server 240 for the purpose of monitoring the wagering activities of players at the gaming terminals 10a, 10b, 10c. The player tracking database server 240 can be used to provide certain players with complimentary services or special offers based on their wagering activities at the various gaming terminals 10a, 10b, 10c. This type of marketing helps the casino 222 to maintain customer loyalty, thereby increasing profitability.

The player tracking database server 240 includes a database with player tracking data for a player playing the wagering game at one of the gaming terminals 10a. When the player inputs his or her identifying information (like player-identification card 50 of FIG. 3, or the other identifying techniques of FIG. 4) into the gaming terminal 10a, the inputted information is passed through the multi-drop serial line 226 to the WAP carousel controller 228. The inputted information is then transferred to the WAP site controller 230, which is then transferred to the player tracking database server 240 of the casino 222.

At the player tracking database server 240, the player can be identified and the identifying information for that player can be transferred back to the WAP site controller 230. That identifying information (e.g., data indicating an alpha-numeric of the player's name and his or her social security number) is then sent back to the game terminal 10a via the WAP carousel controller 228 and also to the WAP central site server 260.

At the WAP central site server 260, by using the identifying information from the player tracking database server 240, the progressive game information for that particular player can be located and transferred back to the WAP site controller 230. This progressive game information would include signals indicating whether a player has access to individual or group progressive games, signals indicating various progressive games to which the player has access, and signals related to the status of certain progressive games to which that player has access. If positive signals are received at the gaming terminal 10a, the gaming terminal 10a then displays information about the restricted-access progressive games that the player may access. The player may choose to enact a certain progressive game or decline to participate in any of the restricted-access progressive games available to him or her. If the player chooses to begin play on one of the restricted-access progressive games, the WAP site controller 230 and WAP central site server 260 then controls all functions related to the restricted-access progressive games.

Unlike FIG. 6, the player can identify himself or herself through the use of a casino player tracking card that he or she uses to receive special incentives from the casino 222. The player tracking data that is used for comparison with the player's inputted information is stored in a memory device within the player tracking database server 240. On the other hand, the data that is used to determine a list of restricted-access progressive games that are available to each player is stored in a different memory device within the WAP central site server 260.

Alternatively, the network 220 in FIG. 7 can be configured such that player tracking data that is present within the player tracking database server 240 is periodically sent to the WAP central site server 260. In this scenario, a memory device within the WAP central site server 260 would include both the player tracking data (from the player tracking database server 240) and the data that describes which progressive games are available to which players. This allows for the building of the central database for the progressive game functions, in that the WAP central site server 260 will know that “player 512” in the player tracking database server 240 in that particular casino 222 is “player 2043” in the WAP central site server 260. Further, because the WAP central site server 260 can be linked to numerous casinos, that same player, “player 2043,” in the WAP central site server 260 may also be “player 851” in a different casino's player tracking database. Hence, that player, “player 2043,” can play the same restricted-access progressive game while wagering at different casinos. Periodic updating of player tracking data in the WAP central site server 260 allows for the WAP site controller 230 to send the inputted player information from the terminals 10a, 10b, 10c directly to the WAP central site server 260 for comparison with data therein, without needing to receive the identifying information from the player tracking database server 240.

Because the player tracking system used by the casino 222 may require the communication of additional information unrelated to the progressive game, the components within the WAP networking system 220 will be transmitting information unrelated to the progressive game. Accordingly, if the WAP network system is controlled by an entity different from the casino 222 (e.g., a gaming machine manufacturer), cooperation between the casino 222 and the manufacturer is required to communicate the proper messages to the player tracking database server 240 within the casino 222. Preferably, the WAP site controller 230 and the player tracking database server 240 communicate through an inter-process communication on a semi-real-time basis.

Alternatively, the network 220 of FIG. 7 can be constructed such that the WAP network performs the entire player tracking function during the gaming session (i.e., from the time the player inputs his or her identifying information to the end of the player's wager session). After the session, the player tracking database server 240 receives a batch-mode communication concerning information about the session so that the memory device within the player tracking database server 240 can be updated. In such an embodiment, the components within the WAP network 220 must be able to identify and record certain types of player tracking events from the gaming terminals 10a, 10b, 10c that are important for the player tracking function of the casino 222.

FIG. 8 illustrates a network 320 that removes some of the necessity for communicating and sharing information with the player tracking database server 240 in the casino 222 of FIG. 7. In FIG. 8, each gaming terminal 10a, 10b, 10c includes at least two communication ports. One port communicates with the player tracking system by transferring information to the player tracking database server 340 via the player tracking concentrator device 342. The other port communicates to the WAP carousel controller 328 for performing functions related to the restricted-access progressive game in the same manner described above with respect to the WAP carousel controller 128 of FIG. 6.

If the player inputs identifying information to be compared with data stored in the player tracking database server 340 in FIG. 8, then that data needs to be shared with the WAP central site server 360 for the purpose of determining the restricted-access progressive games for which the player is eligible. Accordingly, the WAP site controller 330 receives information about the players from the player tracking database server 340 and transmits that information to the WAP central site server 360. As such, a player can use one player identifier card that can be used for tracking the player at the casino 322 and for determining whether the player has access to certain restricted-access progressive games.

As an alternative to FIG. 8, a direct communication line between the WAP carousel controller 328 and the player tracking concentrator device 342 can be utilized. Thus, instead of using two communication ports at the gaming terminals 10, information for both the player tracking function and the progressive game function can be transmitted to the WAP carousel controller 328, which then transfers the necessary player tracking information to the player tracking concentrator device 342.

FIG. 9 illustrates an alternative network 420 in which the player tracking database server 440 shares information with the WAP site controller 430 through an inter-process communication method. In this network 420, the WAP site controller 430 receives all of the necessary player identification information directly from the “back-end” of the player tracking database server 440 on a continuous or near continuous basis.

The WAP site controller 430 receives signals when a player has begun and completed a gaming session at one of the gaming terminals 10a, 10b, 10c. Once the WAP site controller 430 receives information about a certain player playing at a specific gaming terminal 10a, it sends the necessary information to the WAP central site server 460. The WAP central site server 460 determines which, if any, of the restricted-access progressive games are available for that certain player at the gaming terminal 10a and sends corresponding signals back to the WAP site controller 430. The WAP site controller 430 sends the corresponding instructions, which relate to the operation of the restricted-access progressive game, to the gaming terminal 10a via the WAP carousel controller 428. Further, information related to the restricted-access progressive game, including game operation instructions, are passed through the multi-drop serial line 426 between the gaming terminal 10a and the WAP carousel controller 428.

FIG. 9 also illustrates the use of a separate card reader and display device 441a, 441b, 441c for each of the gaming terminals 10a, 10b, 10c. These card reader and display devices 441 can be installed by the casino 422 for the sole purpose of the player tracking function that is often used by the casino 422. Accordingly, in this embodiment, the gaming terminal 10 does not need to have an integral player-identification card reader 24 (FIGS. 1 and 2). As shown, information located on a player-identification card that is inserted into one of the card reader and display devices 441 does not necessarily get transmitted into the gaming terminal 10, but is transmitted to the player tracking database server 440 via the player tracking concentrator device 442. It should be noted that, while not shown in the other embodiments set forth in this specification, the present invention contemplates use of a separate (i.e., not integral) player-identification device (like the card reader 441) for performing the functions associated with identifying a player for the restricted-access progressive game. For example, in FIG. 8, a separate identification device could be attached to the gaming terminals 10a, 10b, 10c for communicating player identification information to the gaming terminals 10a, 10b, 10c, which is then further transmitted to both the progressive game system and the player tracking system.

FIG. 10 illustrates another network 520 for sharing information between the player tracking system and the progressive game system. In this embodiment, each gaming terminals 10a, 10b, 10c has an associated tap 545a, 545b, 545c. When a player inputs his or her identification information to the gaming terminal 10a (whether through an integral player-identification device, like the player-identification card reader 24 of FIG. 1 or the RFID transponder 62 of FIG. 4, or through a separate identification device, like the card reader device 441 of FIG. 9), that information is transmitted to the player tracking concentrator device 542. When doing so, the corresponding tap 545 receives the same information because it bridges the multi-drop serial line 526 and the player tracking line 543. The taps 545 communicate with the WAP carousel controller 528, providing it with information related to the gaming sessions at the gaming terminals 10a, 10b, 10c. The transfer of information is preferably unidirectional through the tap 545 so that it does not interfere with the communications to the player tracking concentrator device 542.

As with the previous embodiments, it is necessary to know information about the players that are playing at the gaming terminals 10a, 10b, 10c. Thus, the WAP site controller 530 receives player tracking data from the player tracking database server 540 and transmits that information to the WAP central site server 560. This transfer of player tracking data can occur on a semi real-time basis, or periodic basis. As with the previous embodiments, to control the operation of the progressive game, the transfer of information is bidirectional between the gaming terminals 10a, 10b, 10c and the WAP carousel controller 528

Often, a proprietary communication protocol may be used for communications between the gaming terminal 10 and the player tracking database server 540. For example, one such protocol is Slot Accounting System (SAS) protocol, which is made by International Gaming Technology (IGT). Consequently, the tap 545 can be one that is dedicated to receiving information according to a certain proprietary protocol and can be, for example, a “SAS tap” as shown in FIG. 10. Additional information about the SAS tap 545 may be found in U.S. Ser. No. 10/409,285, filed Apr. 8, 2003, and entitled “Gaming Terminal Data Monitoring Network”, which is owned by the assignee of the present application and is herein incorporated by reference in its entirety.

In any of the previous embodiments, a player must provide information to the network so that he or she can enroll in the system that allows for playing the restricted-access progressive games. This enrollment can be done at a gaming terminal that has the necessary player input devices to provide information for enrollment. Or, it can be performed on a separate enrollment device located within the casino. Alternatively, enrollment can be performed on an internet site that allows a player to enter information. The enrollment process results in the development of a player identifier, such as a unique player card, that allows a player to be identified that he or she desires to begin playing a restricted-access progressive game at a gaming terminal. The skilled artisan will appreciate numerous other types of enrollment devices that serve the purpose of storing the player's information along with a unique identifier in a database.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. (canceled)

2. (canceled)

3. (canceled)

4. (canceled)

5. (canceled)

6. (canceled)

7. (canceled)

8. A gaming system for playing a restricted-access progressive game, comprising:
a progressive game database containing data, said data including a list of players having access to said restricted-access progressive game;
a progressive game controller for controlling the operation of said restricted-access progressive game, said progressive game controller being coupled to said progressive game database;
at least one gaming terminal coupled to said progressive game controller, said gaming terminal including a player-identification device providing information about a player at said gaming terminal, said gaming terminal sending a player-identifier signal to said progressive game controller; and
wherein, in response to receiving said player-identifier signal, said progressive game controller sends a signal to said gaming terminal indicating whether a player has access to said restricted-access progressive game.

9. The gaming system of claim 8, wherein said progressive game database is a casino database that is also used for tracking information of players.

10. The gaming system of claim 9, wherein communication between said gaming terminal and said progressive game controller occurs, in part, through a casino network coupled to said casino database.

11. The gaming system of claim 8, wherein said gaming terminal receives a wager from a player for a basic wagering game, a portion of said wager being allocated to said restricted-access progressive game.

12. The gaming system of claim 8, wherein said progressive game controller and said progressive game database are located in a remote location from said gaming terminal.

13. The gaming system of claim 8, wherein communication between said gaming terminal and said progressive game controller occurs through a carousel controller coupled to a plurality of gaming terminals.

14. The gaming system of claim 8, further including a plurality of gaming terminals in communication with said progressive game controller, all of said plurality of gaming terminals being capable of playing said restricted-access progressive game.

15. A gaming system for playing restricted-access progressive games, comprising:
a progressive game database containing data, said data including information related to a first restricted-access progressive game that is accessible by only a first group of players and information related to a second restricted-access progressive game that is accessible by only a second group of players;
a controller for determining access to said first and second restricted-access progressive games, said controller being coupled to said progressive game database; and
at least one gaming terminal coupled to said controller, said gaming terminal including a player-identification device providing information about a player at said gaming terminal, said gaming terminal sending a player-identifier signal to said controller to determine whether said player has access to either of said first and second restricted-access progressive games.

16. The gaming system of claim 15, wherein said first group includes only one player.

17. The gaming system of claim 15, wherein said second group includes only one player.

18. The gaming system of claim 15, further including a player-enrollment station coupled to said progressive game database, said player-enrollment station allowing players to provide information for storage in said progressive game database.

19. The gaming system of claim 15, wherein said database is a casino database that is also used for tracking information of players.

20. The gaming system of claim 15, wherein said gaming terminal receives a wager from said player for a basic wagering game and, in response to said player-identifier signal being positive, a portion of said wager being allocated to one of said first and second restricted-access progressive games.

21. The gaming system of claim 15, wherein said gaming terminal receives a wager from said player for a basic wagering game and, in response to said player-identifier signal being positive, a portion of said wager being allocated to both of said first and second restricted-access progressive games.

22. The gaming system of claim 15, wherein said controller is located in a remote location from said gaming terminal.

23. The gaming system of claim 15, wherein said information includes biometric information related to a distinguishable physical attribute of the player.

24. The gaming system of claim 15, wherein said information includes voice-print information from the player.

25. The gaming system of claim 15, wherein said information is derived from a radio frequency identification signal from the player and said player-identification device is a receiver.

26. The gaming system of claim 15, wherein said information is derived from a card inputted by the player and said player-identification device is a card reader.

27. A method of operating a progressive wagering game, comprising:
receiving a player-identification input from a player at a gaming terminal;
transmitting a player-identifier signal from said gaming terminal to a remotely located controller that determines accessibility to said progressive wagering game;
receiving, at said gaming terminal, a progressive game accessibility signal from said remotely located controller; and
in response to said progressive game accessibility signal being positive, allowing the player to conduct said progressive wagering game.

28. The method of claim 27, further including receiving a wager from said player for a basic wagering game and, in response to said progressive game accessibility signal being positive, allocating a portion of said wager to said progressive wagering game.

29. The method of claim 27, further including receiving a player-identification input from a second player at said gaming terminal, and denying access to said progressive wagering game in response to said progressive game accessibility signal for said second player is negative.

30. The method of claim 27, further including repeating said first-named receiving step, said transmitting step, and second-named receiving step at a second gaming terminal and, in response to said progressive game accessibility signal being positive at said second gaming terminal, allowing the player to conduct said progressive wagering game at said second gaming terminal.

31. The method of claim 30, wherein a basic wagering game on said gaming terminal is different from a basic wagering game on said second gaming terminal.

32. The method of claim 30, wherein said gaming terminal and said second gaming terminal are located at different casinos. information from a player at a location that is distinct from said gaming terminal.

33. (canceled)

34. (canceled)

35. (canceled)

36. (canceled)

37. (canceled)

38. (canceled)

39. (canceled)

40. (canceled)
